(19) United States
(12) Patent Application Publication
(10) Pub. No.: US 2007/0282613 A1
(43) Pub. Date: Dec. 6, 2007

(54) Audio buddy lists for speech communication

(75) Inventor: Eric J. Diethorn, Long Valley, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology LLC

(21) Appl. No.: 11/444,183

(22) Filed: May 31, 2006

(51) Int. Cl. G10L 21/00

(52) U.S. Cl. 704/500

(57) ABSTRACT

A method for controlling audio characteristics of communications with another party includes initiating communications between a first communication device of a user and a second communication device and determining, at the first communication device, audio characteristics associated with one of the second communication device or a name of a contact associated with the second communication device. The associated audio characteristics are then used by the first communication device for communications between the first communication device and the second communication device.

### BACKGROUND OF THE INVENTION

1. Field of the Invention

The present invention relates to a method and device for controlling audio characteristics of speech transmissions and receptions at a user's communication device based on the preferences of that user and characteristics of the other communication device involved in the call.

2. Discussion of the Related Art

Conventional telephone bandwidth for audio signals is limited to a narrow frequency band of about 200-3400 Hz, even though speech extends below and well above this frequency range. This limitation was built into conventional phone systems because at the inception of wireline telephony it was difficult to build inexpensive handsets and because the higher frequencies were lost during transmission over copper wires. Improvements to the original telephone systems were designed to be compatible with the existing constraints. Furthermore, limiting the transmission of voice to the narrow band kept the call capacity of the network high by keeping the data rate of each call low. Thus, the narrowband speech limitation for telephony instituted at the inception of wireline telephony has remained in effect.

Current developments in digital telephony systems such as, for example, Voice over Internet Protocol (VoIP) systems, obviate the constraints on speech bandwidth which are required by conventional telephony. In digital telephony, coders/decoders referred to as codecs are used to convert voice signals uttered by users to digital signals. Available now are wide band speech codec schemes that enable telephony in which the wider speech bandwidth—to 7,000 Hz and beyond—is transmitted and received. Although the term wideband telephony does not have a precise definition—it is an expansion of the standard narrowband telephony bandwidth of 200-3400 Hz—it typically refers to a bandwidth of 50-7,000 Hz. For example, the Variable-Rate Multimode Wideband (VRM-WB) speech codec, which is a standard codec for use in third generation (3G) multimedia applications, is designed for encoding the speech bandwidth of 50 to 7,000 Hz. The extension of low frequency to 50 Hz is described as contributing a sense of presence and increasing naturalness and comfort to conversations. The extension of the high frequency to 7000 Hz improves differentiation of certain consonants, thereby improving intelligibility.

Despite all of the above advantages, there are some circumstances in which a user may desire narrowband transmission and/or a different speech coder type. First, a user may wish to communicate at different speech bandwidths, that is, different audio fidelities, based upon the nature and application of a call. For example, one may wish to communicate with known callers using wideband speech and use narrowband speech for unknown callers. Second, some users with speech impediments may desire narrowband transmissions because wideband transmissions can increase the perception of those speech impediments by other parties. Third, other users may simply prefer the traditional or conventional sound associated with narrowband. Last, a user may desire narrowband transmission to accommodate another party having equipment which only receives narrowband transmissions, although in such a case nearly all packet-speech telephony systems based on existing standards will automatically arbitrate to the common, narrowband speech codec. Accordingly, a device is needed which allows a user of a communication device to control audio characteristics of communications dependent on characteristics of the call.

### SUMMARY OF THE INVENTION

A method is disclosed for controlling audio characteristics of communications with another party, including the steps of initiating communications between a first communication device of a user and a second communication device, determining, at the first communication device, audio characteristics associated with one of the second communication device, a name of a contact associated with the second communication device, or an application purpose associated with the second communication device, and using the associated audio characteristics for communications between the first communication device and the second communication device.

The first communication device stores a list of contacts in a memory, i.e., a buddy list. The list of contacts may include names of people that the user calls and devices that the user contacts such as a conference bridge, a voicemail system, or other servers. The list includes information associated with each of the contacts. The step of determining comprises determining the audio characteristics based on the information in the list. The information may directly list the audio characteristics to be used for the communications. Alternatively, the information may comprise characteristics of the contact associated with the second device, the audio characteristics being determined based on the characteristics of the contact. The characteristics of the contact may comprise an indication of whether the contact is personal or work related. The characteristics of the contact may additionally or alternatively comprise at least one of name, age, gender, work function, and time of day.

The step of determining may comprise first determining whether the second device or a name of a contact associated with the second device is on the list. In this case, the step of using the associated audio characteristics is performed only if it is determined that the second device or a name of a contact associated with the second device is on the list. The step of using comprises using a default set of audio characteristics if the second device or a name of a contact associated with the second device is not on the list.

The audio characteristics to be determined comprise one of a codec algorithm and speech bandwidth to be used for communications. Furthermore, separate characteristics may be defined for transmission and reception for communications at the first communication device.

If the device is capable of video communications, video characteristics associated with one of the second communication device or a name of a contact associated with the second communication device may be determined, the video characteristics being used for communications between the first communication device and the second communication device. The video characteristics include at least one of video frame rate and quality, or video fidelity.

A telecommunication device is also disclosed having a memory storing computer executable instructions for controlling audio characteristics of communications with another party, the computer executable instructions include instructions for performing the steps of determining, at the first communication device, audio characteristics associated with one of the second communication device, a name of a contact associated with the second communication device, or an application purpose associated with the second communication device, in response to initiation of communications between the first communication device of a user and a second communication device, and using the associated audio characteristics for communications between the first communication device and the second communication device.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram showing a system in which the present invention is implemented;

FIG. 2 is a block diagram showing an Internet Protocol (IP) communication device according to an embodiment of the present invention; and

FIG. 3 is a flow diagram showing the steps according to a method of the present invention.

### DETAILED DESCRIPTION OF THE PRESENTLY PREFERRED EMBODIMENTS

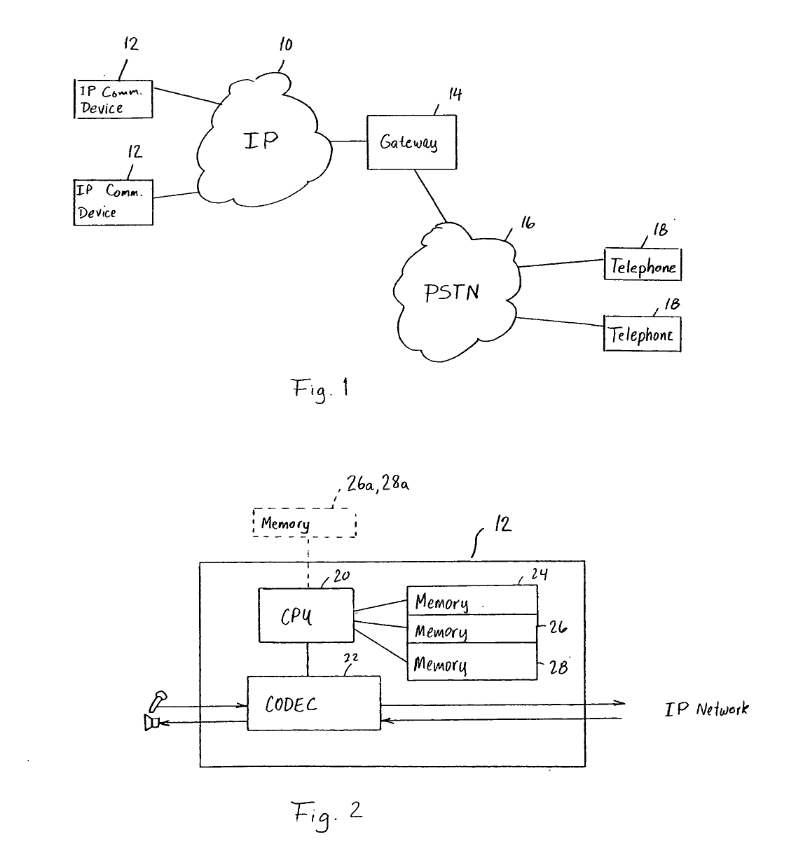

FIG. 1 shows a system in which the present application may be implemented. An Internet Protocol (IP) network 10, such as, for example, the Internet or a Voice over Internet Protocol (VoIP) network, is shown connected to IP phones 12. VoIP allows phone calls to be transmitted from one IP phone 12 to another over the IP network 10. The IP phones 12 may also communicate with a traditional phone 18 connected to a public switched telephone network (PSTN) 16 through a gateway 14 connected between the IP network 10 and the PSTN 16. The gateway 14 performs a translation of the IP telephony signal to a format that is compatible with the PSTN 16, and vice versa.

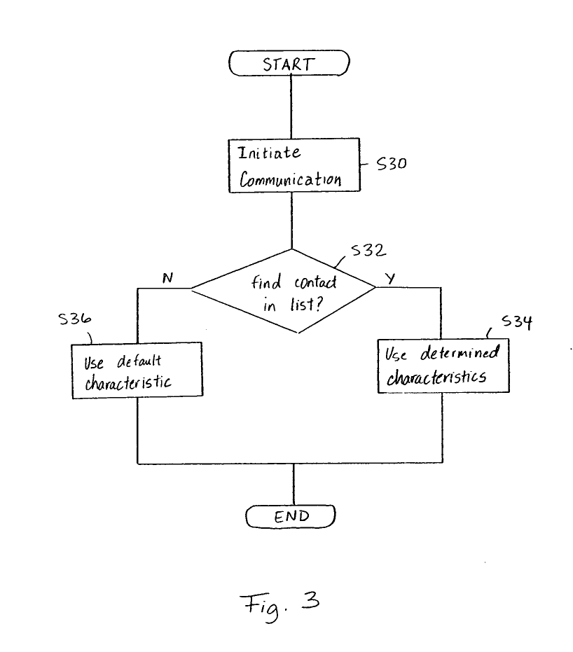

FIG. 2 shows that the IP phone 12 includes a processor (CPU) 20 which is connected to a coder/decoder (codec) 22 which converts an audio signal uttered by a user to a digital form according to a codec algorithm. Likewise, the codec 22 converts a received digital signal to an audio signal which is played back by a loudspeaker on the phone 12 in accordance with the codec algorithm. Although the CPU 20 and codec 22 are shown separately, they may be included in a single component. The CPU 20 runs a program for providing the communication and any other functions of the IP phone 12. The program is stored in a first memory 24 which comprises a Read Only Memory (ROM), Random Access Memory (RAM), or any other known or hereafter developed memory for storing computer executable instructions.

According to the invention, the IP phone 12 is capable of controlling the audio characteristics of signals transmitted or received based on characteristics of the call. Although the present specification uses a specific example of an IP phone 12, the present invention is applicable to any device capable of communicating via IP telephony. Examples of other devices include an analog telephone adaptor (ATA) and a computer. However, any other known or hereafter developed device capable of IP telephony communications may also be used. The audio characteristics to be controlled include speech bandwidth and the speech codec algorithm to be used for coding and decoding the signals. For this purpose, a second memory 26 connected to the processor 20 stores a plurality of codec algorithms, each generating signals having different audio characteristics. The second memory 26 may comprise any know or hereafter developed type of memory such as the above-mentioned ROM and RAM. A third memory 28 may store a list of contacts, i.e., a buddy list, including a list of people or devices with whom the user of the IP phone 12 communicates. The first, second, and third memories 24, 26, 28 may comprise separate components. Alternatively, the first, second, and third memories, or any pair thereof, may comprise sections of a single memory component.

The plurality of codec algorithm and the list of contacts may alternatively be stored in one or more external network elements such as a memories 26a, 28a connectable to the IP phone via the Internet. Such network elements may be accessible to the user by login procedures.

In one embodiment of the invention, the third memory 28 also stores the audio characteristic preferences for each of the contacts. According to this embodiment, the CPU 20 instructs the codec 22 to use a specific algorithm and/or a specific bandwidth for transmission and reception of communications based on which contact the user is communicating with by looking up such information in the third memory 28.

According to another embodiment, the third memory 28 stores characteristics of each of the contacts, such as whether the contact is personal or work related contact and the work function, gender, or age of the contact. According to this embodiment, the audio characteristics to be used for a call are determined based on the characteristics of the contact. For example, wideband communications may only be used for personal contacts. In another example, narrowband communications may only be used for contacts that are unknown, for example, when the user receives a sales call of unknown origin.

If the IP phone 12 or other communication device is capable of video communications, the video communication fidelity may be similarly controlled. The video fidelity characteristics to be controlled include video frame rate and quality or video fidelity. Additionally, the user may wish to automatically control, using the contacts list, the choreography or composition of an image transmitted to another user during a call. For example, a user may use a portrait for friends and a full-body or less detailed image for other contacts.

FIG. 3 is a flow diagram showing steps according to an embodiment of the present invention. In step S30, communications with the user's IP phone 12 are initiated. The initiation of communications may comprise receiving a call or making a call by the user. In response to step S30, the CPU of the IP phone determines whether information is available about the other device involved in the call to determine audio characteristics to be used for the communication during the call, step S32. This step includes looking up the name or number of the other device involved in the call or looking up a name of the contact associated with the other device in a list in the third memory 28 of the user's phone 12. If it is determined that information is available, then the audio characteristics associated with the other device are determined based on the information in the third memory 28, step S34. The audio characteristics to be determined comprise the speech bandwidth and the type of speech codec algorithm. The information in the second memory may directly indicate the audio characteristics to be used. Alternatively, the audio characteristics to be used may be determined from characteristics of the contact associated with other phone involved in the call. In this case, the determination may be based on name, work function, gender, age of the other party, or time-of-day.

If it is determined in step S32 that information can not be found for the other party, then a default set of audio characteristics are used, step S36. The default set may be set by the user.

Once the characteristics are determined, the CPU retrieves the correct codec algorithm from the second memory 24 and commences communications using the retrieved codec.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling audio characteristics of communications with another party, comprising the steps of:
initiating communications between a first communication device of a user and a second communication device;
determining, at the first communication device, audio characteristics associated with one of the second communication device, a name of a contact associated with the second communication device, or an application purpose associated with the second communication device; and
using the associated audio characteristics for communications between the first communication device and the second communication device.

2. The method of claim 1, further comprising the step of storing a list of contacts in a memory, the list including information associated with each of the contacts, wherein said step of determining comprises determining the audio characteristics based on the information in the list.

3. The method of claim 2, wherein the information directly lists the audio characteristics to be used for the communications.

4. The method of claim 2, wherein the information comprises characteristics of the contact associated with the second communication device, said audio characteristics being determined based on the characteristics of the contact.

5. The method of claim 4, wherein the characteristics of the contact comprise an indication of whether the contact is personal or work related.

6. The method of claim 4, wherein the characteristics of the contact comprise at least one of name, age, gender, work function, and time-of-day.

7. The method of claim 1, further comprising the step of storing a list of contacts in a memory, the list including information associated with each of the contacts, wherein said step of determining comprises first determining whether the second communication device or a name of a contact associated with the second communication device is on the list, and said step of using the associated audio characteristics is performed if it is determined that the second device or a name of a contact associated with the second device is on the list.

8. The method of claim 7, wherein said step of using comprises using a default set of audio characteristics if the second communication device or a name of a contact associated with the second communication device is not on the list.

9. The method of claim 1, wherein said audio characteristics comprise a codec algorithm and speech bandwidth to be used for communications.

10. The method of claim 1, wherein said audio characteristics defines separate characteristics for transmission and reception of communications at the first communication device.

11. The method of claim 1, further comprising the steps of determining, at the first communication device, video characteristics associated with one of the second communication device or a name of a contact associated with the second communication device, and using the associated video characteristics for communications between the first communication device and the second communication device, the video characteristics including at least one of video frame rate, quality, and choreography or composition of an image.

12. A first telecommunication device having a memory storing computer executable instructions for controlling audio characteristics of communications with another party, said computer executable instructions for performing the steps of:
at initiation of communications between said first communication device and a second communication device, determining, at said first communication device, audio characteristics associated with one of the second communication device, a name of a contact associated with the second communication device, or an application purpose associated with the second communication device; and
using, by said first communication device, the associated audio characteristics for communications with the second communication device.

13. The device of claim 12, further comprising one of a memory storing a list of contacts and means for accessing the memory, said list including information associated with each of the contacts, wherein said computer executable instructions for performing said step of determining comprises instructions for determining the audio characteristics based on the information in said list.

14. The device of claim 13, wherein the information directly lists the audio characteristics to be used for the communications.

15. The device of claim 13, wherein the information comprises characteristics of the contact associated with the second communication device, said computer executable instructions for performing the step of determining comprise determining the audio characteristics based on the characteristics of the contact.

16. The device of claim 15, wherein the characteristics of the contact comprise an indication of whether the contact is personal or work related.

17. The device of claim 15, wherein the characteristics of the contact comprise at least one of name, age, gender, work function, and time-of-day.

18. The device of claim 12, further comprising a memory storing a list of contacts or means for accessing the memory, said list including information associated with each of the contacts, wherein said computer executable instructions for performing the step of determining comprise instructions for first determining whether the second communication device or a name of a contact associated with the second communication device is on the list, and said computer executable instructions for performing the step of using the associated audio characteristics includes instructions for performing the step of using only if it is determined that the second communication device or a name of a contact associated with the second communication device is on the list.

19. The device of claim 18, wherein said computer executable instructions for performing the step of using comprises instructions for using a default set of audio characteristics if the second communication device or a name of a contact associated with the second communication device is not on the list.

20. The device of claim 12, wherein said audio characteristics comprise one of a codec algorithm and speech bandwidth to be used for communications.

21. The device of claim 12, wherein said audio characteristics defines separate characteristics for transmission and reception of the communications.

22. The device of claim 12, wherein said computer executable instructions further include instructions for performing the steps of determining, at the first communication device, video characteristics associated with one of the second communication device or a name of a contact associated with the second communication device, and using the associated video characteristics for communications between the first communication device and the second communication device, said video characteristics including at least one of video frame rate, quality, and choreography or composition of an image.
